(19) United States
(12) Patent Application Publication
(10) Pub. No.: US 2007/0274224 A1
(43) Pub. Date: Nov. 29, 2007

(54) PATH SETTING METHOD, NODE DEVICE, AND MONITORING/CONTROL DEVICE

(76) Inventors: Motoki Suzuki, Yokohama (JP); Yasuyuki Fukashiro, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/749,773

(22) Filed: May 17, 2007

(30) Foreign Application Priority Data
May 24, 2006 (JP) 2006-143758

(51) Int. Cl. H04J 3/14; H04L 12/28

(52) U.S. Cl. 370/248; 370/351

(57) ABSTRACT

In a network in which GMPLS-implemented nodes and GMPLS-not-implemented nodes coexist, the GMPLS-implemented nodes cannot control the GMPLS-not-implemented nodes. To solve this, the GMPLS-implemented nodes suspend GMPLS control when the GMPLS control is started, and transmit a GMPLS control start message to a monitoring/control device. The monitoring/control device determines whether GMPLS-not-implemented nodes exist on a GMPLS control target LSP, when they exist, performs all settings necessary for the GMPLS-not-implemented nodes, and then transmits a GMPLS control suspension release message to resume the GMPLS control.

### CLAIM OF PRIORITY

The present application claims priority from Japanese patent application serial no. 2006-143758, filed on May 24, 2006, the content of which is hereby incorporated by reference into this application.

### BACKGROUND OF THE INVENTION

The present invention relates to a path setting method, node devices, and a monitoring/control device in an optical transmission system used in a backbone network intended for international or domestic coverage, or urban areas, local networks, and the like. More particularly, it relates to an efficient path setting method, node devices, and a monitoring/control device in a state in which GMPLS (Generalized Multi-Protocol Label Switching)-implemented nodes and GMPLS-not-implemented nodes coexist.

Recently, in transmission devices, research and development of inter-node mutual control technology has been briskly made. As inter-node mutual control technology, GMPLS technology is available as technology for opening a communication route by use of a label in a communication network including transmission devices and the like. The GMLS technology, which is described in non-patent document 1 (RFC3945), is expected as means for achieving efficient network management to provide for diversified devices on networks such as routers, time division multiplexers, and OXC (Optical Cross-Connect)/PXC (Photonic Cross-Connect) as a result of the emergence of diversified services and an increase in transmission capacity.

With GMPLS, by a signaling protocol such as GMPLS RSVP-TE (ReSerVation Protocol-Traffic Engineering), and a routing protocol such as OSPF-TE (Traffic Engineering Extensions to OSPF (Open Shortest Path First)), LSP (Label Switched Path) can be opened by use of a label on a communication network including a packet switch such as a router, a time division multiplexer such as SONET (Synchronous Optical Network)/SDH (Synchronous Digital Hierarchy), and a wavelength switch such as OXC/PXC. The GMPLS RSVP-TE is described in non-patent document 2 (RFC3437), and the OSPF-TE is described in non-patent document 3 (RFC3630).

As part of a current communication network, a monitoring/control device such as NMS (Network Management System) that uses protocols such as SNMP (Simple Network Management Protocol) and TL1 (Transaction Language 1) exists as a device that centrally manages the communication network.

A study is underway of technology for coherently opening LSP to a destination client through a core network including SONET/SDH and OXC/PXC by use of user control protocols such as O-UNI (Optical-User Network Interface), OIF-UNI-01.0 R2, and GMPLS UNI, and GMPLS in a transmitting client device. The OIF-UNI-01.0 R2 is described in non-patent document 4, and GMPLS UNI is described in non-patent document 5.

As transmission capacity increases, main signals accommodated in a transmission device become higher in communication speed and larger in capacity. Therefore, time from failure occurrence to recovery is required to be as short as possible in communication networks.

With technology described in non-patent document 6, GMPLS RSVP-TE is extended, and when failure is detected in an end point node of LSP, or failure information is notified to an end point node by a Notify message, LSP failure recovery is enabled by switching to a backup route. As technology for switching to a usable backup route, 1+1 unidirectional protection, 1+1 bidirectional protection, 1:1 protection, 1:N protection, and Re-routing are available.

[Non-patent Reference 1] E. Mannie, “Generalized Multi-Protocol Label Switching (GMPLS) Architecture”, [online], October 2004, IETF, retrieved on Apr. 20, 2006, Internet <URL:http://www.ietf.org/rfc/rfc3945.txt?number=3945>

[Non-patent Reference 2] L. Berger, “Generalized Multi-Protocol Label Switching (GMPLS) Signaling Resource ReserVation Protocol-Traffic Engineering (RSVP-TE) Extensions”, [online], January 2003, IETF, retrieved on Apr. 20, 2006, Internet <URL:http://www.ietf.org/rfc/rfc3473.txt?number=3473>

[Non-patent Reference 3] D. Katz and two others, “Traffic Engineering (TE) Extensions to OSPF Version 2”, [online], September 2003, IETF, retrieved on Apr. 20, 2006, Internet <URL:http://www.ietf.org/rfc/rfc3630.txt?number=3630>

[Non-patent Reference 4] “User Network Interface (UNI) 1.0 Signaling Specification, Release 2”, [online], Feb. 27, 2004, OIF, retrieved on Apr. 20, 2006, Internet <URL:http://www.oiforum.com/public/documents/OIF-UNI-01.0-R 2-Common.pdf>

[Non-patent Reference 5] G. Swallow and three others, “Generalized Multiprotocol Label Switching (GMPLS) User-Network Interface (UNI): Resource ReserVation Protocol-Traffic Engineering (RSVP-TE) Support for the Overlay Model”, [online], October 2005, IETF, retrieved on Apr. 20, 2006, Internet <URL:http://www.ietf.org/rfc/rfc4208.txt?number=4208>

[Non-patent Reference 6] J. P. Lang and two others, “RSVP-TE Extensions in support of End-to-End Generalized Multi-Protocol Label Switching (GMPLS)-based Recovery draft-ietf-ccamp-gmpls-recovery-e2e-signaling-03.txt”, [online], April 2005, IETF, retrieved on Apr. 21, 2006, Internet <URL:http://www.ietf.org/internet-drafts/draft-ietf-ccamp-gmpls-recovery-e2e-signaling-03.txt>

### SUMMARY OF THE INVENTION

Since GMPLS-not-implemented nodes not implementing GMPLS functions exist in existing communication networks, a communication network may be built in which GMPLS-not-implemented nodes and GMPLS-implemented nodes coexist.

In a communication network in which GMPLS-implemented nodes and GMPLS-not-implemented nodes coexist, since the GMPLS-not-implemented nodes cannot be recognized from the GMPLS-implemented nodes, control by GMPLS cannot be performed. Therefore, in order to quickly and efficiently utilize resources by controlling, by GMPLS, LSP through which the GMPLS-not-implemented nodes also pass, all settings necessary for the GMPLS-not-implemented nodes must have been completed. To effectively utilize resources, it is necessary to perform settings for the GMPLS-not-implemented nodes upon the occurrence of abrupt and dynamic reservation and allocation of resources by GMPLS.

Since, in GMPLS, depending on its utilization form, resources are reserved and allocated abruptly and dynamically, the present technology has difficulty in completing in advance all settings necessary for GMPLS-not-implemented nodes. Furthermore, the present technology has difficulty in performing settings for GMPLS-not-implemented nodes upon the occurrence of reservation and allocation of resources by GMPLS.

With the technology described in the Non-patent Reference 1, even after switching to a backup route for failure recovery, when GMPLS-not-implemented nodes exist in the backup route, or when settings for GMPLS-not-implemented nodes are not completed, a failure state continues despite LSP after the switching. As a result, failure recovery cannot be performed.

When reservation and allocation of resources occur abruptly or dynamically in GMPLS, the present invention determines by a monitoring/control device whether GMPLS-not-implemented nodes exist on a route, when the GMPLS-not-implemented nodes exist, suspends processing by GMPLS, automatically determines settings necessary for the GMPLS-not-implemented nodes, completes the settings for them, then resumes the processing by GMPLS, thereby solving the above problem. This is described below more specifically.

First, each node is provided with a communication interface with the monitoring/control device, and the monitoring/control device acquires device configuration information and network configuration information of each node via the communication interface. The monitoring/control device stores the acquired device configuration information in a device configuration information database. By consulting the device configuration information database, the monitoring/control device controls a communication network including communication devices that do not implement GMPLS, and communication devices that implement GMPLS.

Second, the GMPLS-implemented nodes have a function to send a GMPLS control message to the monitoring/control device. The GMPLS control message tells the monitoring/control device that an event requiring dynamic reservation and allocation of resources have occurred in the GMPLS-implemented nodes. When detecting the event, the monitoring/control device determines whether to perform presetting.

Third, the monitoring/control device has a GMPLS routing calculation function, and when detecting an event requiring dynamic reservation and allocation of resources, calculates a route selected in the GMPLS-implemented nodes. The monitoring/control device determines whether GMPLS-not-implemented nodes exist on the route selected by GMPLS, and when they exist on the route, performs settings necessary for GMPLS processing such as data switch setting, for all GMPLS-not-implemented nodes that exist on the route.

By any one of the above-described means, at least one of problems below is solved.

First, since all settings necessary in advance for GMPLS-not-implemented nodes can be completed, during LSP opening by GMPLS, obstructions to main signal conduction due to the GMPLS-not-implemented nodes can be removed.

Second, since all settings necessary in advance for GMPLS-not-implemented nodes can be completed, during switching to a backup route by GMPLS, obstructions to GMPLS failure recovery due to communication equipment not implementing GMPLS can be removed.

Third, since the monitoring/control device centrally manages device configuration and network configuration information, loads on a GMPLS processing function part within the GMPLS-implemented nodes can be reduced.

### BRIEF DESCRIPTION OF THE DRAWINGS

FIG. 1 is a block diagram of a communication network;

FIG. 2 is a block diagram for explaining a core network;

FIG. 3 is a block diagram of a GMPLS-implemented node;

FIG. 4 is a block diagram of a GMPLS-not-implemented node;

FIG. 5 is a block diagram of monitoring/control device;

FIG. 6 is a transition diagram for explaining device configuration notification processing;

FIG. 7 is a table for explaining a device configuration database;

FIG. 8 is a transition diagram for explaining network configuration notification processing;

FIG. 9 is a table for explaining a network configuration database;

FIG. 10 is a transition diagram explaining GMPLS processing start notification;

FIG. 11 is a flowchart showing presetting processing of a monitoring/control device for GMPLS-not-implemented nodes; and

FIG. 12 is a transition diagram for explaining presetting processing for GMPLS-not-implemented nodes.

### DETAILED DESCRIPTION OF THE PREFERRED EMBODIMENTS

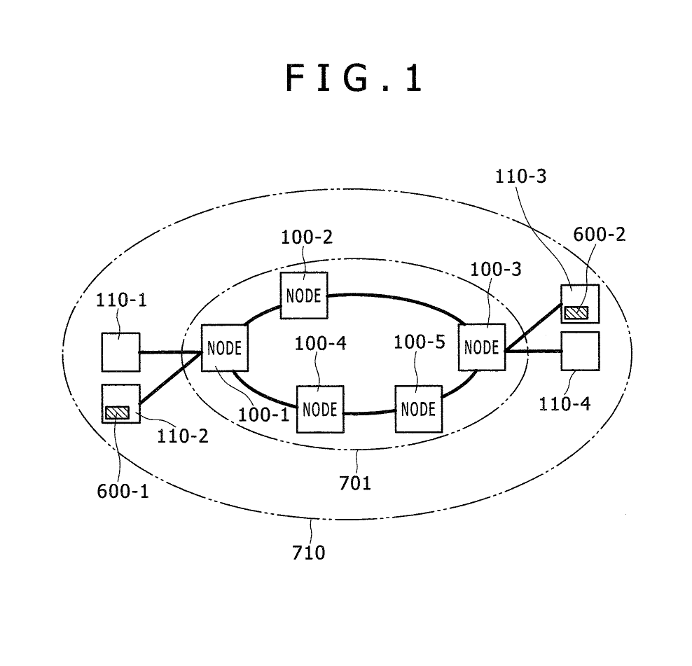

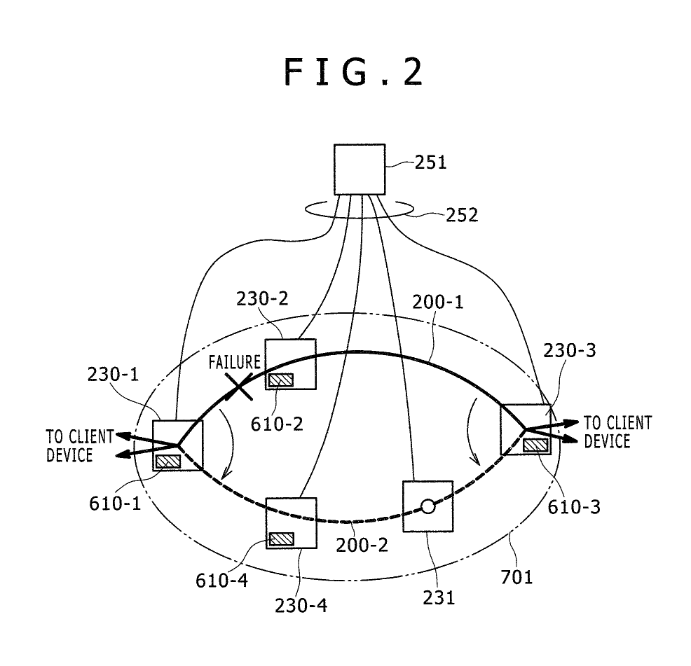

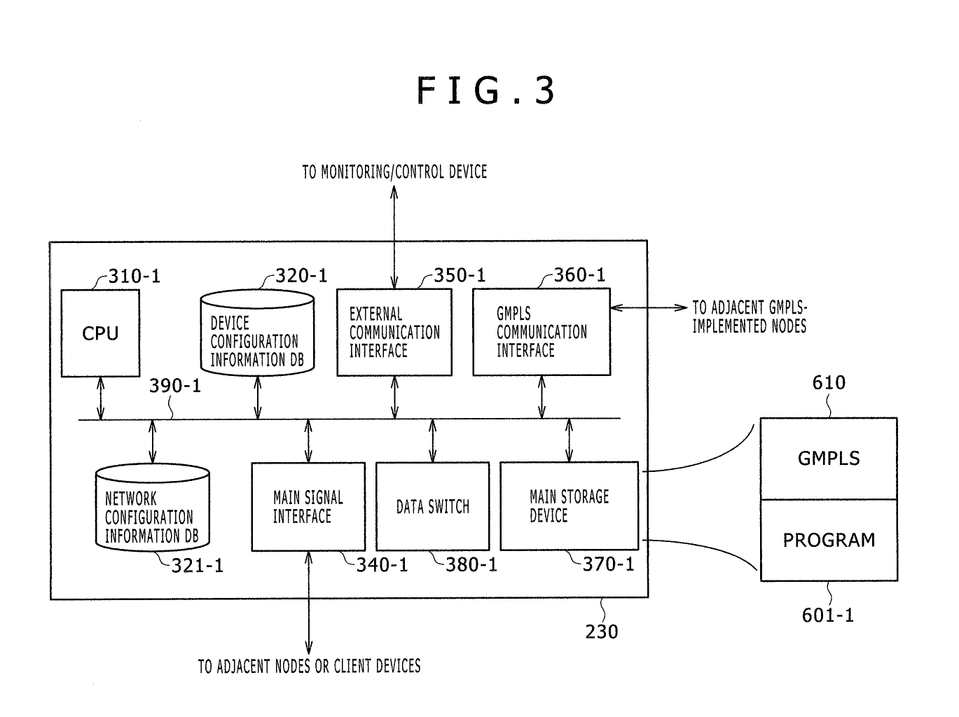

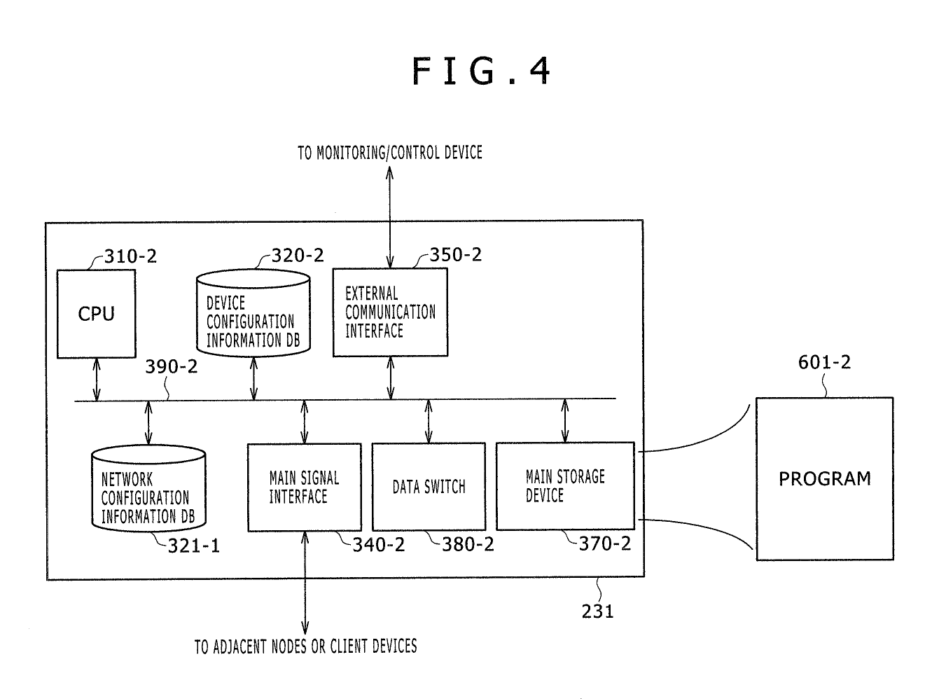

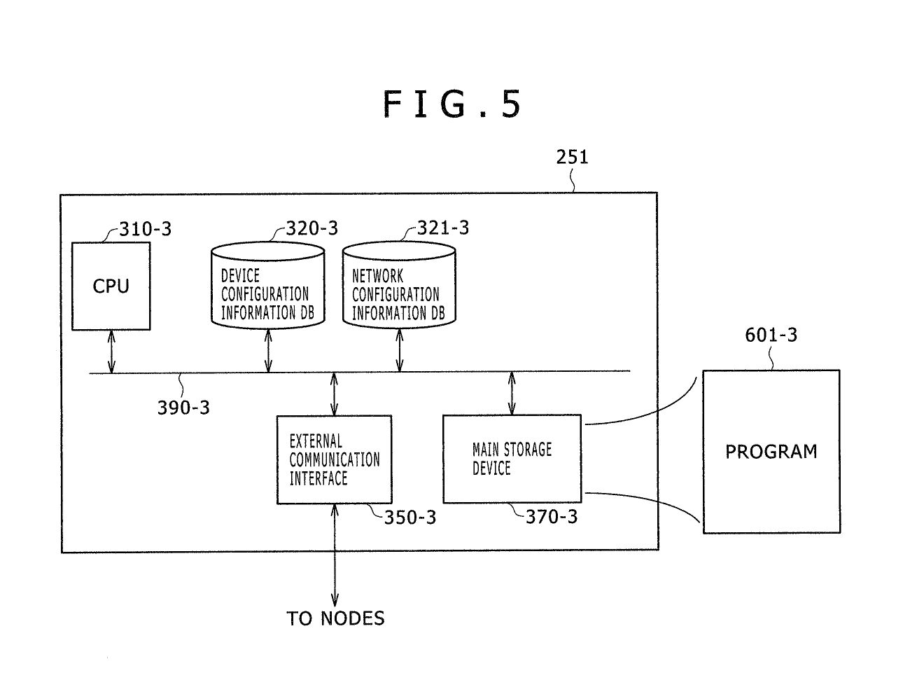

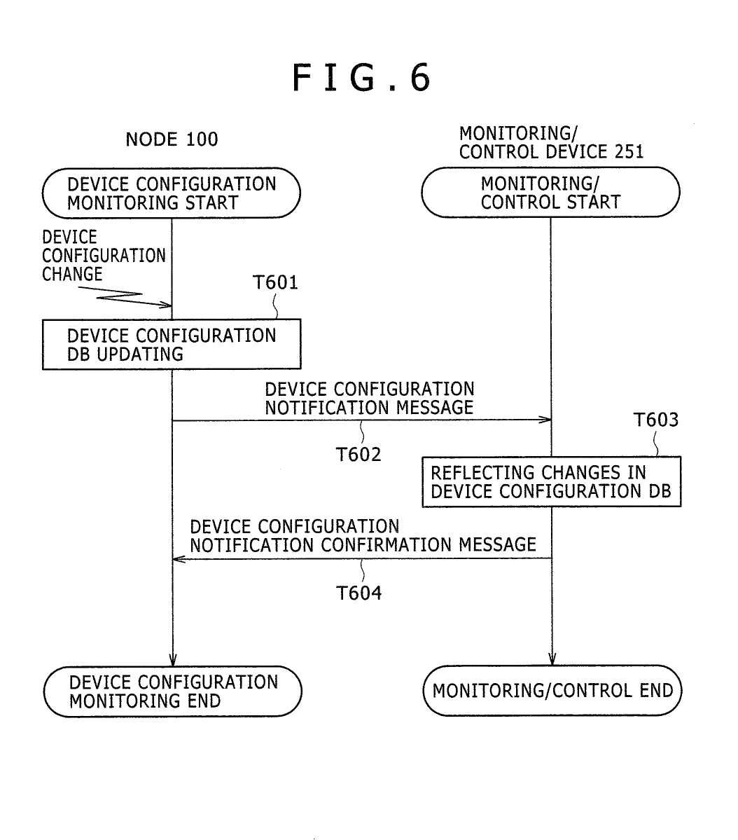

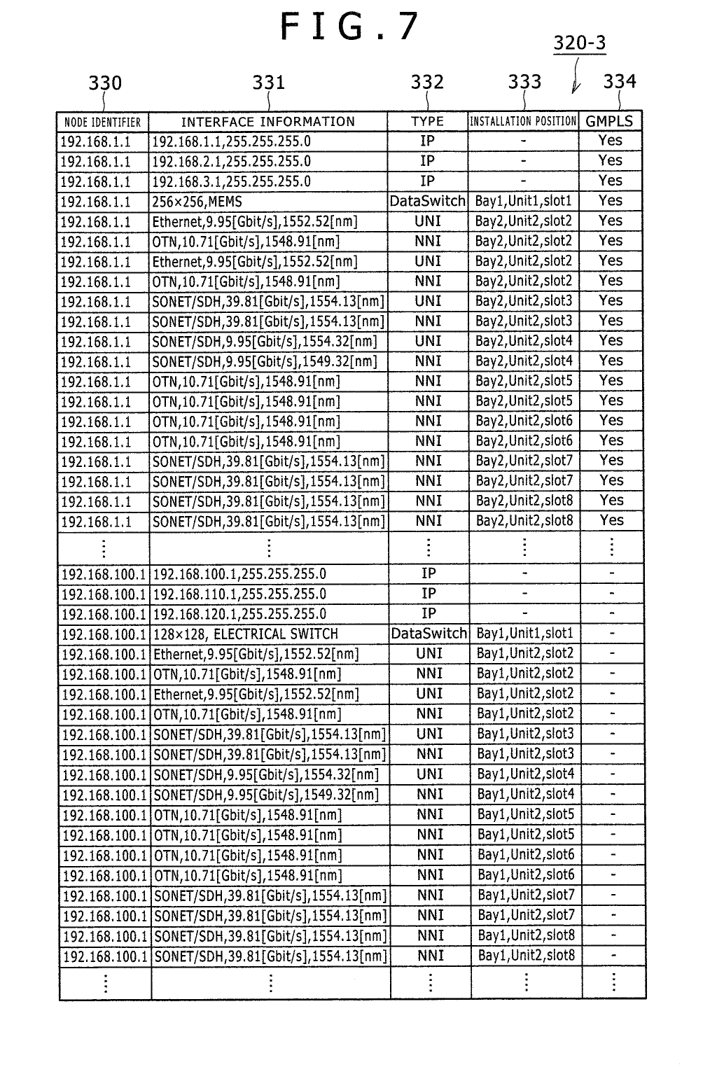

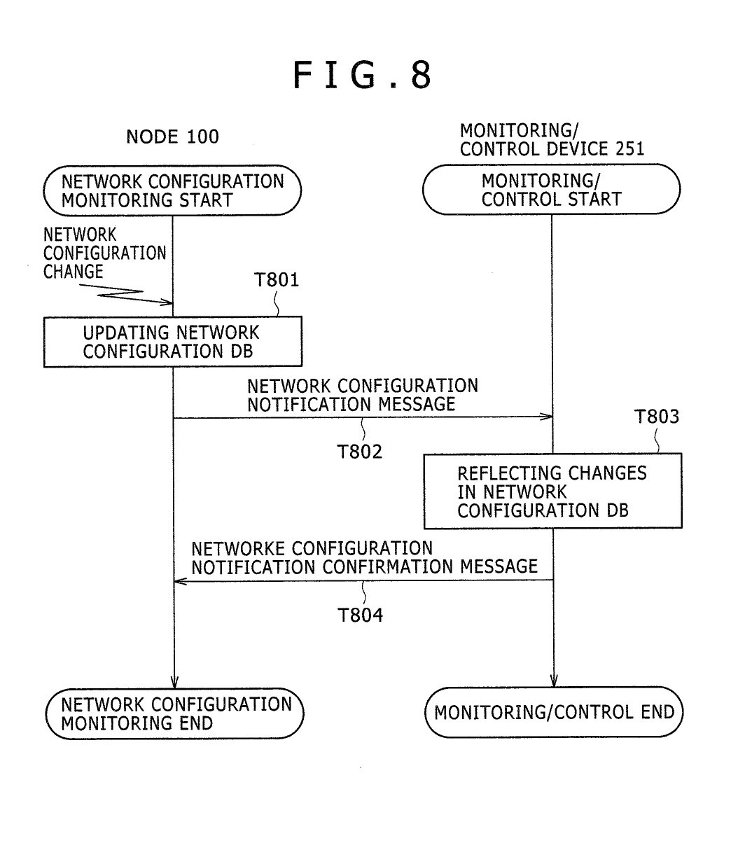

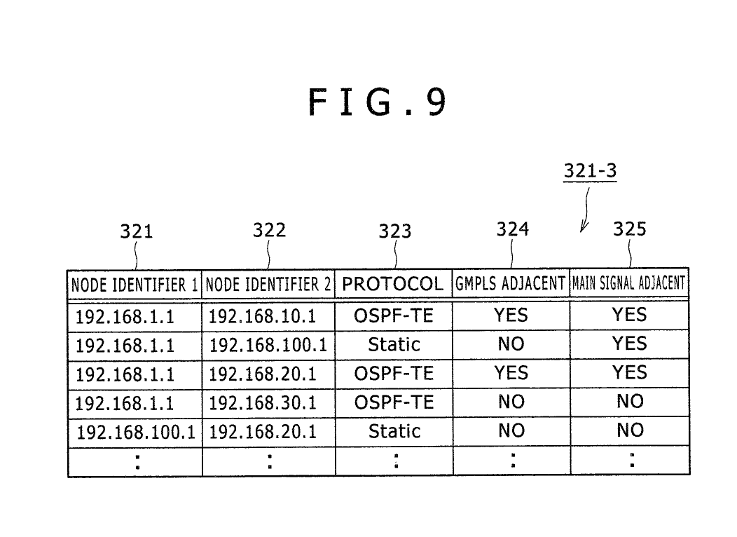

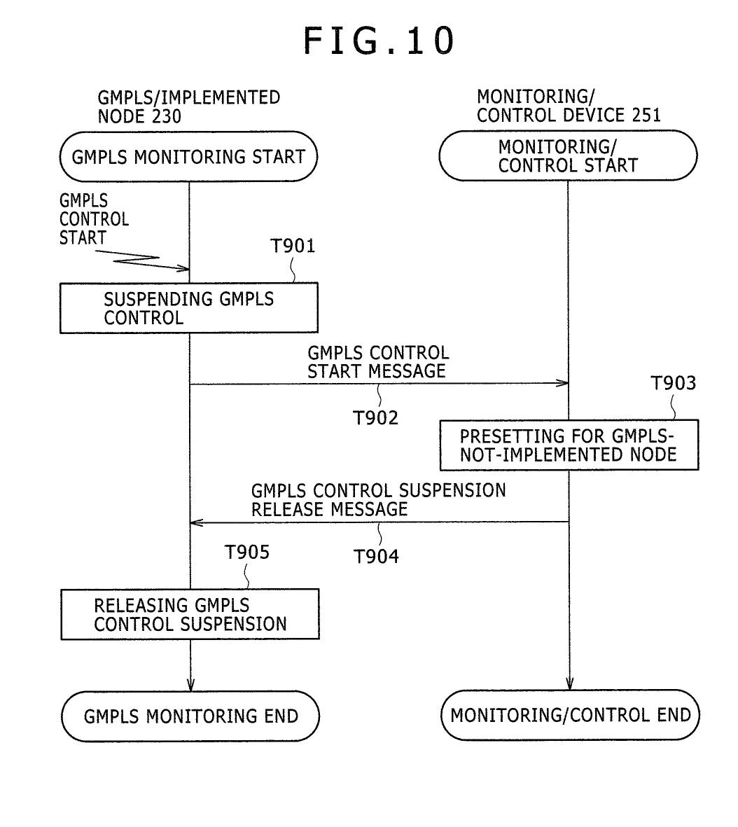

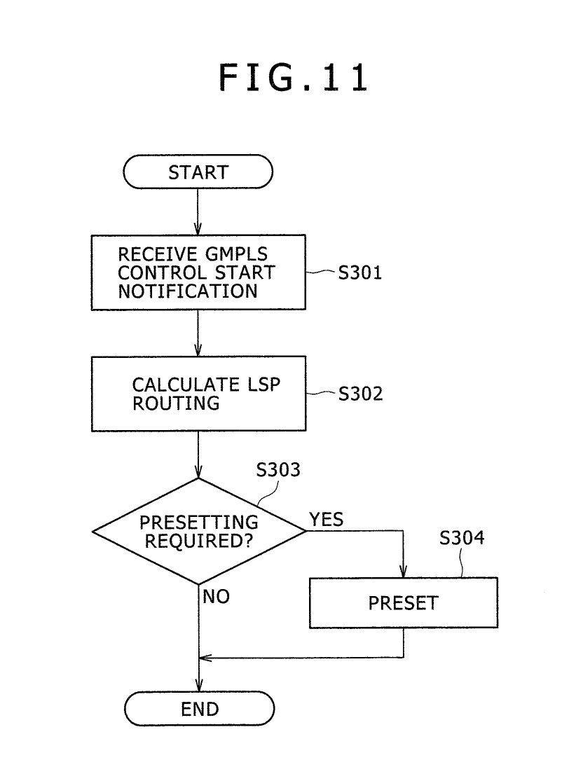

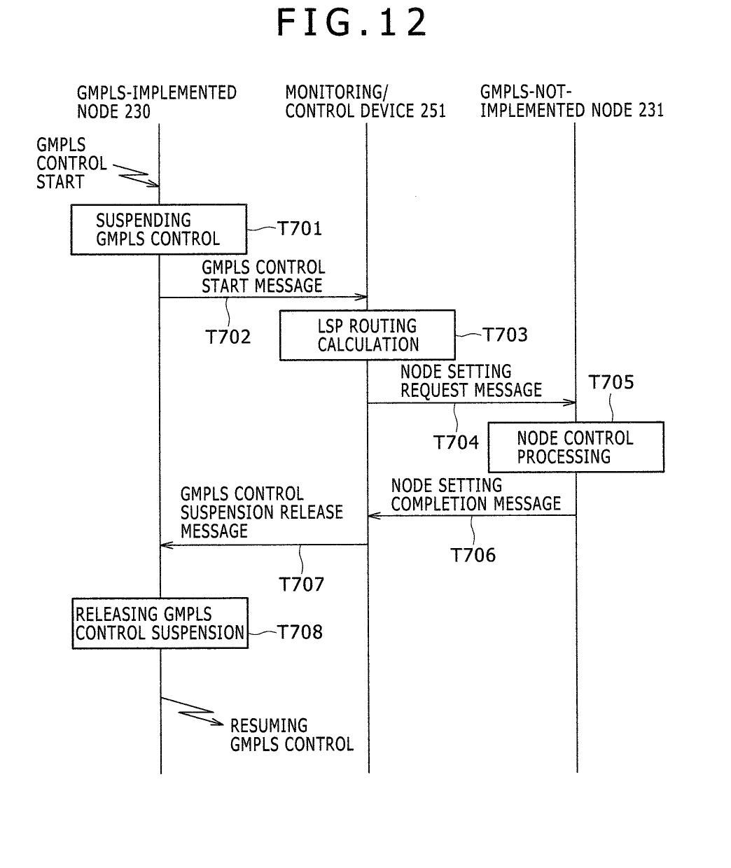

Hereinafter, preferred embodiments of the present invention will be described with reference to the accompanying drawings. It is understood that identical reference numbers are assigned to substantially identical members, and duplicate descriptions are avoided. FIG. 1 is a block diagram of a communication network. FIG. 2 is a block diagram for explaining a core network. FIG. 3 is a block diagram of a GMPLS-implemented node. FIG. 4 is a block diagram of a GMPLS-not-implemented node. FIG. 5 is a block diagram of monitoring/control device. FIG. 6 is a transition diagram for explaining device configuration notification processing. FIG. 7 is a table for explaining a device configuration database. FIG. 8 is a transition diagram for explaining network configuration notification processing. FIG. 9 is a table for explaining a network configuration database. FIG. 10 is a transition diagram explaining GMPLS processing start notification. FIG. 11 is a flowchart showing presetting processing of a monitoring/control device for GMPLS-not-implemented nodes. FIG. 12 is a transition diagram for explaining presetting processing for GMPLS-not-implemented nodes.

First, a communication network to embody the present invention is described using FIG. 1.

A communication network 710 shown in FIG. 1 constitutes a core network 701 by nodes 100-1 to 100-5 such as router, layer 2 switch, layer 3 switch, WDM (Wavelength Division Multiplexing), SONET/SDH, and OXC/PXC. The nodes are connected with client devices 110-1 to 110-4 such as router, layer 2 switch, layer 3 switch, and SONET/SDH. User control protocols 600-1 and 600-2 may be installed as programs in the client devices 110. As the user control protocols, protocols such as RSVP-TE, GMPLS-UNI, and O-UNI are available.

Programs in this embodiment may be executed as required by hardware processing such as FPGA (Field Programmable Gate Array), DSP (Digital Signal Processor), and network processor.

The following describes a core network. The core network 701 shown in FIG. 2 includes GMPLS-implemented nodes 230, a GMPLS-not-implemented node 231, a monitoring/control device 251, and control signal lines 252 for connecting the nodes and the monitoring/control device. The GMPLS-implemented nodes 230 are provided with GMPLS 610, thereby enabling GMPLS-based mutual control between the nodes.

In FIG. 2, an active LSP (Label Switched Path) 200-1 is opened by GMPLS on a main signal of the GMPLS-implemented nodes 230-1, 230-2, and 230-3. When a failure occurs on the active LSP 200-1, switching occurs to a backup LSP 200-2 on a main signal of the GMPLS-implemented nodes 230-1 and 230-4, a GMPLS-not-implemented node 231, and the GMPLS-implemented node 230-3. The backup LSP 200-2 may be opened before a failure occurs. In this specification, nodes implementing the GMPLS protocol are referred to as “GMPLS-implemented nodes”, nodes not implementing the GMPLS protocol are referred to as “GMPLS-not-implemented nodes”, and the two types of nodes are referred to simply as “nodes” when they are not differentiated for description. The monitoring/control device shown in FIG. 2 may monitor and control the client devices. The control signal line 252 may be wireless.

The following describes the hardware configuration of GMPLS-implemented nodes with reference to FIG. 3. The GMPLS-implemented nodes 230 include a central processing unit (CPU) 310-1, an internal communication line 390-1 such as bus, an external communication interface 350-1, a GMPLS communication interface 360-1, a device configuration information database 320-1, a network configuration information database 321-1, a main signal interface 340-1, a data switch 380-1, and a main storage device 370-1.

The main storage device 370-1, which is a rewritable semiconductor memory such as RAM (Random Access Memory), stores a program 601-1 executed by the CPU 310-1 and the GMPLS protocol 610. The main storage device 370-1 may store the device configuration information database 320-1 or the network configuration information database 321-1.

The device configuration information database 320-1 or the network configuration information database 321-1 may be stored on secondary storage devices such as hard disks. As the secondary storages, rewritable nonvolatile semiconductor memories such as Flash ROM (Read Only Memory), Compact Flash, SSFDC (Solid State Floppy Disk Card), and SD memory card (Secure Digital memory card) may be used.

Two or more of the main signal interface 340-1 may be provided if necessary. The main signal interface 340-1 employs a signal system such as Ethernet stipulated by IEEE 802.3, 802.3z, 802.3ae, and the like, SONET/SDH stipulated by “International Telecommunication Union Telecommunication Standardization Sector” (ITU-T) G.707 and G.783, and OTN (Optical Transport Network) stipulated by ITU-T G.709 and the like. The main signal interface 340-1 is connected with other adjacent nodes, and used for the exchange of user data. The main signal interface 340-1 is further connected with the client devices, and used to exchange user data with the client devices. The data switch 380-1 is selected from an electrical switch, an optical switch of MEMS (Micro Electro Mechanical Systems) system, an optical switch of PLC (Planar Lightwave Circuit) system, a time division multiplex switch, an ADD/DROP switch, and the like, and switches main signals for connection.

The GMPLS communication interface 360-1 is connected with other adjacent GMPLS-implemented nodes. Via the GMPLS communication interface, control signals such as routing protocols and signaling protocols, and data such as device configuration information are exchanged. The GMPLS communication interface 360-1 may use the same interface as a main signal interface according to the requirements of GMPLS.

The external communication interface 350-1 is connected with the monitoring/control device 251. The external communication interface 350-1 exchanges data such as network configuration information and device configuration information with the monitoring/control device 251 by use of protocols such as SNMP, HDLC (High-level Data Link Control procedure), and TL1.

The GMPLS protocol 610 and the program 601-1 are stored in the main storage device 370-1, and processing stipulated in GMPLS by the GMPLS protocol is performed by the CPU 310-1. By executing the program 601-1, in the core network shown in FIG. 2, device configuration information is transferred from the nodes to the monitoring/control device (described later using FIG. 6), and network configuration information is transferred from the nodes to the monitoring/control device (described later using FIG. 8). Furthermore, by transferring a GMPLS control start message from the GMPLS-implemented nodes to the monitoring/control device by processing of FIG. 10 (described later using FIG. 10), presetting processing for the GMPLS-not-implemented node is performed in the monitoring/control device (described using FIG. 11) The program on the main storage may perform other than the above-described processing as required.

The following describes the hardware configuration of a GMPLS-not-implemented node with reference to FIG. 4. The GMPLS-not-implemented nodes 231 includes a central processing unit (CPU) 310-2, an internal communication line 390-2 such as bus, an external communication interface 350-2, a device configuration information database 320-2, a network configuration information database 321-2, a main signal interface 340-2, a data switch 380-2, and a main storage device 370-2.

The main storage device 370-2, which is a rewritable semiconductor memory such as RAM, stores a program 601-2 executed by the CPU 310-2. The main storage device 370-2 may store the device configuration information database 320-2 or the network configuration information database 321-2.

The device configuration information database 320-2 or the network configuration information database 321-2 may be stored on secondary storage devices such as hard disks. As the secondary storage devices, rewritable nonvolatile semiconductor memories such as Flash ROM, Compact Flash, SSFDC, and SD memory card may be used.

Like the GMPLS-implemented nodes 230, two or more of the main signal interface 340-2 may be provided if necessary. The main signal interface 340-2 employs a signal system such as Ethernet, SONET/SDH, and OTN. The main signal interface 340-2 is connected with other adjacent nodes, and used for the exchange of user data. The main signal interface 340-2 is further connected with the client devices, and used to exchange user data with the client devices. The data switch 380-2 is selected from an electrical switch, an optical switch of MEMS system, an optical switch of PLC system, a time division multiplex switch, an ADD/DROP switch, and the like, and switches main signals for connection.

Like GMPLS-implemented nodes 230, the external communication interface 350-2 is connected with the monitoring/control device 251. The external communication interface 350-2 exchanges data such as network configuration information and device configuration information with the monitoring/control device 251 by use of protocols such as SNMP, HDLC, and TL1.

The main storage device 370-2 stores the program 601-2. With the CPU 310-2 executing the program, in the core network shown in FIG. 2, device configuration information is transferred from the nodes to the monitoring/control device, and network configuration information is transferred from the nodes to the monitoring/control device. By a command from the monitoring/control device 251, the CPU 310-2 performs presetting processing for path switching. The program on the main storage device may perform other than the above-described processing as required.

The following describes the hardware configuration of the monitoring/control device with reference to FIG. 5. The monitoring/control device 251 include a central processing unit (CPU) 310-3, an internal communication line 390-3 such as bus, an external communication interface 350-3, a device configuration information database 320-3, a network configuration information database 321-3, and a main storage device 370-3.

The external communication interface 350-3 is connected with the nodes, and exchanges data such as network configuration information and device configuration information with the monitoring/control device 251 with them by use of protocols such as SNMP, HDLC, and TL1.

The main storage device 370-3 stores a program 601-3. With the CPU 310-3 executing the program 601-3, in the core network shown in FIG. 2, device configuration information and network configuration information on all nodes in the core network are acquired to create the device configuration information database 320-3 and the network configuration information database 321-3. The program 601-3 on the main storage device 370-3 may instruct the CPU 310-3 to perform other than the above-described processing as required.

The device configuration information database 320-3 and the network configuration information database 321-3 may be stored on secondary storage devices such as hard disks. They may be stored on the main storage device 370-3. As the secondary storage devices, rewritable nonvolatile semiconductor memories such as Flash ROM, Compact Flash, SSFDC, and an SD memory card may be used.

With reference to FIG. 6, device configuration notification processing between a node and the monitoring/control device is described. The node 100 updates the device configuration database 320-1 or 320-2 when a change occurs in the device configuration of the main signal interface, the data switch, and the like as a result of operations by the operator (T601). The node 100 that have performed the updating processing transmits a device configuration notification message to the monitoring/control device 251 via the control signal line (T602). The device configuration notification message contains change contents of the device configuration. The monitoring/control device 251 executes a program stored in the main storage device 370-3 according to the received device configuration notification message, thereby updating the device configuration information database 320-3 (T603). The monitoring/control device 251 notifies the node 100 of the completion of updating of the device configuration information database by use of a device configuration notification confirmation message (T604). The node 100 that have received the device configuration notification confirmation message detect that synchronization with the device configuration information database in the nodes is completed by the updating of the device configuration information database in the monitoring/control device. The device configuration notification confirmation message may have contents indicating a request to retransmit the device configuration notification message, depending on an updating result of the device configuration information database in the monitoring/control device. When the device configuration information database in the monitoring/control device is unsuccessfully updated, the device configuration notification confirmation message may contain contents indicating the cause of failure. The device configuration notification processing may be repeatedly performed during automatic updating or in other cases, or may be performed once by the judgment of the operator.

Furthermore, the nodes 100 hold a value (node identifier) capable of uniquely identifying a node such as IP address, node ID, and node name, information (interface information) about the GMPLS communication interface 360, external communication interface 350, main signal interface 340, and data switch 380, an interface type, and an installation position. When the nodes 100 are GMPLS-implemented nodes, they further hold information indicating a GMPLS-implemented node.

The interface type uses a value capable of uniquely identifying information about which of the GMPLS communication interface 360, external communication interface 350, main signal interface 340, and data switch 380. When the interface is the main signal interface 340, an identifier capable of uniquely identifying an interface connected with the client devices and an interface connected with the nodes is used.

When the interface type is the GMPLS communication interface 360 or external communication interface 350, the nodes 100 hold information such as an IP address and a subnet mask as interface information. When the interface type is the main signal interface 340, the nodes 100 hold information about frame formats such as Ethernet, OTN, and SONET/SDH, communication speed information of a main signal, and wave-length information of the main signal as interface information. When the type is the data switch 380, the nodes 100 hold information indicating the switching capability of the data switch, and information indicating the type of the data switch such as MEMS and an electrical switch as interface information.

The installation position held in the nodes is information capable of uniquely identifying the positions in which the respective interfaces are installed, such as a frame number, a unit number, and a slot position.

The nodes 100 transfer these pieces of information to the monitoring/control device 251 via the control line by use of the device configuration notification message. Thus, the device configuration database shown in FIG. 7 is constructed in the monitoring/control device 251. In FIG. 7, the device configuration database 320-3 includes node identifies 330, interface information 331, interface type 332, installation position 333, and GMPLS 334 indicating whether a node concerned is a GMPLS node (Yes) or not (-). When the nodes 100 are GMPLS-not-implemented nodes, since information indicating GMPLS-implemented nodes is not contained in the device configuration notification message, “-” is set in the GMPLS 334.

With reference to FIG. 8, network configuration notification processing between a node and the monitoring/control device is described. When a change occurs in the network configuration as a result of operations by the operator, the node 100 updates the network configuration database 321-1 or 321-2 (T801). The node 100 that have performed the updating processing transmits a network configuration notification message to the monitoring/control device 251 via the control signal line (T802). The network configuration notification message contains change contents of the device configuration. The monitoring/control device 251 executes a program stored in the main storage device 370-3 according to the received network configuration notification message, thereby updating the network configuration information database 321-3 (T803). The monitoring/control device 251 notifies the node 100 of the completion of updating of the network configuration information database by use of a network configuration notification confirmation message (T804). The node 100 that have received the network configuration notification confirmation message detects that synchronization with the network configuration information database in the node is completed by the updating of the network configuration information database in the monitoring/control device. The network configuration notification confirmation message may have contents indicating a request to retransmit the network configuration notification message, depending on an updating result of the network configuration information database in the monitoring/control device. When the network configuration information database in the monitoring/control device is unsuccessfully updated, the network configuration notification confirmation message may contain contents indicating the cause of failure. The network configuration notification processing may be repeatedly performed during automatic updating or in other cases, or may be performed once by the judgment of the operator.

The nodes 100 collect information on the network configuration by use of a routing protocol such as OSPF-TE. Information on the network configuration may be manually set by the operator. As a result, the nodes 100 hold a value (node identifier) capable of uniquely identifying a node such as IP address, node ID, and node name, node identifiers of adjacent nodes, and protocol information as information about means by which the network configuration information is acquired. When the nodes 100 are GMPLS-implemented nodes, the nodes 100 further hold GMPLS adjacent relation information indicating whether to form a GMPLS adjacent relation. The GMPLS adjacent relation is formed only between GMPLS-implemented nodes. GMPLS-not-implemented nodes cannot form a GMPLS adjacent relation because they do not implement GMPLS. The nodes 100 hold main signal adjacent information indicating whether main signal interfaces are connected with each other. The GMPLS adjacent relation and the main signal adjacent information may be collected using OSPF-TE and LMP (Link Management Protocol), or may be manually set by the operator. By use of a dynamic routing protocol such as OSPF-TE, information about nodes not in adjacent relation can be collected.

The nodes 100 transfer these pieces of information to the monitoring/control device 251 via the control line by use of the network configuration notification message. Thus, the monitoring/control device 251 constructs the network configuration database 321-3.

In FIG. 9, the network configuration database 321-3 includes node identifiers 1 321, and for each of the node identifiers 1 321, a node identifier 2 322 adjacent to the node identifiers, a protocol 323, GMPLS adjacent 324, and main signal adjacent 325. The GMPLS adjacent 324 is set to “Yes” when both a node of node identifier 1 and a node of node identifier 2 are GMPLS-implemented nodes and the main signal adjacent is “Yes”.

The following describes GMPLS processing start notification with reference to FIG. 10. The GMPLS-implemented node 230 monitors the occurrence of LSP opening processing, LSP deletion processing, and LSP switching processing by GMPLS. When processing by GMPLS is started on the occurrence of these events, the GMPLS-implemented node 230 performs GMPLS control suspension processing (T901). Next, the GMPLS-implemented node 230 transmits a GMPLS control start message to the monitoring/control device 251 (T902). In this case, the GMPLS control start message contains the type of switching processing such as 1+1 path protection in the LSP switching processing and information about a backup route. When an intermediate route is specified in the LSP opening processing, information about the intermediate route may be contained. Furthermore, in the case of LSP deletion processing, the GMPLS control start notification message may contain information such as path ID and a path name capable of uniquely identifying LSP to be deleted.

GMPLS control may time out because of GMPLS control suspension processing during a series of processings. By transmitting a message indicating that GMPLS control is suspended and processing in the monitoring/control device is in progress to other GMPLS-implemented nodes, processing failure due to time-out can be prevented.

On receiving the GMPLS control start message, the monitoring/control device 251 performs presetting processing for communication equipment on a backup route (T903). On completion of the presetting, the monitoring/control device 251 transmits a GMPLS control suspension release message to the GMPLS-implemented node 230 (T904).

On receiving the GMPLS control suspension release message, the GMPLS-implemented node 230 releases the control suspension by GMPLS (T905), and performs processing stipulated in GMPLS. The processing of FIG. 10 is usually repeatedly performed.

The following describes in detail presetting processing for the GMPLS-not-implemented node 231 on a backup route with reference to FIG. 11. The presetting processing is detailed contents of T903 of FIG. 10. When receiving the GMPLS control start message (S301), the monitoring/control device 251 performs routing calculation on LSP after GMPLS control, based on information contained in the GMPLS control start message (S302). The monitoring/control device 251 determines whether presetting for the GMPLS-not-implemented node is necessary, by determining whether the GMPLS-not-implemented node exists in the LSP route (S303). When determining from backup routing calculation that a GMPLS-not-implemented node exists on a backup route and presetting is necessary, the monitoring/control device 251 performs data switch presetting necessary for the GMPLS-not-implemented node (S304). The monitoring/control device 251 terminates the processing when no GMPLS-not-implemented node exists on the backup route in Step 303 (transitions to T904 of FIG. 10).

With reference to FIG. 12, the following describes the operation of a GMPLS-implemented node, the monitoring/control device, and a GMPLS-not-implemented node when the GMPLS-not-implemented node exists on a switching route. In FIG. 12, when starting GMPLS processing, the GMPLS-implemented node 230 performs GMPLS control suspension (T701). The GMPLS-implemented node 230 transmits a GMPLS control start message to the monitoring/control device 251 (T702).

On receiving the GMPLS control start message, the monitoring/control device 251 performs LSP routing calculation (T703). The monitoring/control device 251 transmits setting information such as data switch cross-connect connection setting information and main signal interface light-emitting control information that are required to conduct a main signal, to the GMPLS-not-implemented node 231 that exists on the switching route by use of a node setting request message (T704) On receiving the node setting request message, the GMPLS-not-implemented node 231 interprets the received message, and performs node control processing requested from the monitoring/control device 251 (T705). After completion of the node control processing, the GMPLS-not-implemented node 231 transmits a node setting completion message to the monitoring/control device 251 (T706). The node setting completion message may contain contents indicating that the requested setting is completed in the GMPLS-not-implemented node 231, or contents indicating the cause of setting failure if so.

On receiving the node setting completion message, the monitoring/control device 251 transmits a GMPLS control suspension release message to the GMPLS-implemented node 230 (T707).

After receiving the GMPLS control suspension release message, the GMPLS-implemented node 230 releases the control suspension by GMPLS (T708) and resume the GMPLS control.

Although, in the above-described embodiment, the number of GMPLS-not-implemented nodes on the backup route of the core network is one, when there are plural GMPLS-not-implemented nodes on the backup route, necessary data switch setting is performed for all GMPLS-not-implemented nodes on the backup route.

Although inter-node mutual control technology is described above using GMPLS as an example, the present invention is not limited to GMPLS. Specifically, in the above-described embodiments, even in a network that employs inter-node mutual control technology other than GMPLS, and user control protocols other than RSVP-TE and O-UNI, if a monitoring/control device exists in the network and the above-described control method or devices are used, even when nodes that implement an inter-node mutual control protocol, and nodes that do not implement it coexist, control can be performed through cooperation between them.

According to the present invention, in a communication network in which GMPLS-implemented nodes and GMPLS-not-implemented nodes coexist, GMPLS-based efficient LSP opening processing including GMPLS-not-implemented nodes is enabled by cooperatively operating them. Moreover, even when GMPLS-not-implementing equipment exists, GMPLS-based efficient failure recovery including GMPLS-not-implemented nodes is enabled.

1. A path setting method of a network comprising first nodes that implement an inter-node mutual control protocol, second nodes that do not implement said inter-node mutual control protocol, and a monitoring/control device that controls said first node and said second node, the method comprising the steps of:
suspending path setting control by use of said inter-node mutual control protocol in said first nodes that serve as the origin of path setting control path of opening, deletion, or change by use of said inter-node mutual control protocol;
transmitting a first message to notify said monitoring/control device of the start of path setting control;
calculating a path setting route upon the receipt of said first message in said monitoring/control device;
performing path setting control for said second nodes included in the calculated path setting; and
transmitting a second message to said first nodes that have sent said first message.

2. The path setting method of claim 1,
further comprising the step of resuming said path setting control suspended in said first nodes that have received said setting completion message.

3. A node device that switches main signals by a data switch, implementing GMPLS and a user control protocol, and comprising device configuration notification means and network configuration notification means for a monitoring/control device, and
when GMPLS control is started, transmitting GMPLS control notification to said monitoring/control device, and suspending said GMPLS control.

4. The node device of claim 3,
upon receiving a response from said monitoring/control device, resuming said GMPLS control.

5. The node device of claim 3,
wherein said user control protocol is O-UNI, GMPLS-UNI, or RSVP-TE.

6. A monitoring/control device,
receiving device configuration information and network configuration information from node devices, storing said device configuration information and said network configuration information in a database, and
upon receiving a GMPLS start message from a GMPLS-implemented node, performing routing calculation, based on said database.

7. The monitoring/control device of claim 6,
when GMPLS-not-implemented nodes exist on a route obtained by said routing calculation, transmitting a node setting request message to the GMPLS-not-implemented nodes.
